(19) United States
(12) Patent Application Publication
(10) Pub. No.: US 2020/0167858 A1
(43) Pub. Date: May 28, 2020

(54) Mobile Reverse Bidding System and Method

(71) Applicant: Better That Pty LTD, Balmain, NSW (AU)

(72) Inventor: John PHILLIPS, Brisbane (AU)

(21) Appl. No.: 16/632,855

(22) PCT Filed: Jul. 23, 2018
(86) PCT No.: PCT/AU2018/000119

§ 371 Date: Jan. 21, 2020

(30) Foreign Application Priority Data
Jul. 24, 2017 (AU) 2017902890

(51) Int. Cl. G06Q 30/08; G06Q 20/32; G06Q 20/04; G06Q 30/06

(52) U.S. Cl. CPC G06Q 30/08; G06Q 30/0641; G06Q 20/0453; G06Q 20/322

(57) ABSTRACT

A reverse bidding method including at least one server, the reverse bidding method comprising the steps of: a. entering, using an electronic device associated with a buyer, an identifier associated with a product; b. sending, with the electronic device, the identifier to an online reverse bidding system c. generating, with the online reverse bidding system, a purchase request for the product; d. maintaining an electronic database of one or more sellers in association with the online reverse bidding system; e. sending, with the online reverse bidding system, the purchase request to at least one of the one or more sellers; f. receiving, with the online reverse bidding system, one or more sale offers from at least one of the one or more sellers in response to the purchase request; and g. accepting, with the online reverse bidding system, a preferred sale offer.

### TECHNICAL FIELD

The present invention relates to a mobile reverse bidding system and method. In particular, the present invention relates to a mobile reverse bidding system and method adapted to connect buyers to online and retail vendors.

### BACKGROUND ART

A reverse auction is a type of auction in which the roles of the buyer and seller are reversed. In a reverse auction, sellers compete to obtain business from a buyer by offering increasingly lower prices for goods or services.

In existing reverse auction applications, a buyer identifies a product or services that it wishes to purchase in an online marketplace and then multiple sellers are able to complete to offer progressively lower prices for the sale of the product or services to the buyer.

While existing reverse auction applications are convenient for buyers wishing to purchase services (because the scope of the service may be readily set out in the online marketplace), the purchase of products can be less straightforward. This is because, to obtain relevant offers, a buyer must clearly identify the exact product it wishes to purchase (including model numbers, product codes and the like). A failure to provide full details of the product can result in a situation in which the buyer does not receive the product it wishes to purchase.

In addition, existing reverse auction applications are Internet based, and typically do not support mobile users, location services or traditional retail outlets.

Thus, there would be an advantage if it were possible to provide a reverse bidding system and method that allowed for rapid and accurate identification of products and services that a buyer (particularly mobile users) wishes to purchase, while also allowing additional sellers (including traditional retail outlets) to bid on the reverse auction.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a mobile reverse bidding system and method, which may at least partially overcome at least one of the abovementioned disadvantages or provide the consumer with a useful or commercial choice.

With the foregoing in view, the present invention in a first aspect, resides broadly in a reverse bidding method including at least one server, the reverse bidding method comprising the steps of:
a) entering, using an electronic device associated with a buyer, an identifier associated with a product;
b) sending, with the electronic device, the identifier to an online reverse bidding system
c) generating, with the online reverse bidding system, a purchase request for the product;
d) maintaining an electronic database of one or more sellers in association with the online reverse bidding system;
e) sending, with the online reverse bidding system, the purchase request to at least one of the one or more sellers;
f) receiving, with the online reverse bidding system, one or more sale offers from at least one of the one or more sellers in response to the purchase request; and
g) accepting, with the online reverse bidding system, a preferred sale offer.

As stated above, a buyer enters an identifier associated with a product into an electronic device associated with the buyer. The electronic device may be of any suitable form, and may include a computer or the like. More preferably, however, the electronic device comprises a mobile electronic device, such as a mobile telephone, computer tablet or the like. Thus, in this embodiment of the invention, the reverse bidding method comprises a mobile reverse bidding method.

The identifier may be of any suitable form. For instance, the identifier may include a scan of an electronically readable element. Any suitable electronically readable element may be used. For instance, the electronically readable element may include a barcode, such as a one dimensional barcode or a two dimensional barcode. In some embodiments of the invention, the electronically readable element may be a Quick Response (QR) code, while in other embodiments of the invention, the electronically readable element may comprise an RFID tag. It is envisaged that the scanning of the electronically readable element may be achieved using the electronic device, and particularly a camera associated with the electronic device.

In other embodiments of the invention, the identifier may include an image. In this embodiment of the invention, it is preferred that the image may be a digital image. More preferably, it is preferred that the image may be generated by a camera associated with the electronic device associated with the buyer. The image may be of any suitable subject. For instance, the image may be an image of the product, an image of a portion of a product (for instance, a portion of the product on which the brand is provided), an image of a serial number, manufacturer's label or the like, or any suitable combination thereof.

In embodiments of the invention in which the image contains text, it is envisaged that the text may be converted to a machine readable format. For instance, the image may be an Optical Code Reader (OCR) image.

In an alternative embodiment of the invention, the identifier may be entered manually by the buyer. In this embodiment of the invention, the identifier may be entered (e.g. by typing, converted from handwriting to text, etc.) as text into the electronic device.

In some embodiments of the invention, the identifier sent to the online reverse bidding system may include sufficient information to clearly identify the product. For instance, a barcode, an image of a manufacturer's label, model number or serial number, etc. may provide sufficient information to allow the online reverse bidding system to identify the product and generate a purchase request.

It is envisaged that there may be times when the identifier may not contain sufficient information to identify the product. For instance, if a buyer enters an incomplete serial number into the online reverse bidding system, or misspells a product name, it may not be possible to identify a single product associated with the incomplete information entered by the buyer.

In this embodiment of the invention, it is envisaged that the online reverse bidding system may maintain an electronic product database. It is envisaged that the electronic product database may include information on a plurality of products. Any suitable information may be included in the electronic product database, including, but not limited to, product brands, names, serial or catalogue numbers, technical specifications, dimensions, energy efficiency and/or safety ratings, wholesale and/or retail prices, availability and so on, or any suitable combination thereof.

If the identifier sent to the online reverse bidding system does not include sufficient information to fully identify the product, the online reverse bidding system may consult the electronic product database to identify any products that match the incomplete information entered by the buyer. In this embodiment, it is envisaged that the buyer may be able to browse the electronic product database to identify and select the desired product, or the online reverse bidding system may provide the buyer with two or more products that match the incomplete information and request a selection from the buyer.

The product may be of any suitable form. For instance, the product may comprise food and beverages (including alcoholic beverages), electronic goods, tobacco products, furniture and furnishings, homewares, clothing and footwear, media (such as compact discs, DVDs, BluRay discs etc.), vehicles and accessories therefor, hardware and the like. In essence, it is envisaged that any product that carries an electronically readable element could be used in connection with the present method. In some embodiments of the invention, it is envisaged that the product could also include services with which an electronically readable element is associated. Any suitable services are envisaged, such as, but not limited to, utility supply (e.g. water, gas or electricity supply), telephone or internet supply or the like.

The buyer may be located at any suitable location when scanning the electronically readable element. However, in a preferred embodiment of the invention, the buyer may be located in a retail store when scanning the electronically readable element. In this way, the buyer may readily identify the product it wishes to purchase with a high degree of accuracy, minimising or eliminating the risk of generating a purchase request for the wrong product.

In addition, by allowing the buyer to scan an electronically readable element using a mobile electronic device, the buyer may have access to more products that can be purchased than prior art reverse auction platforms. Further, the ability to access more products for purchase means that more sellers can participate in the reverse auction than prior art reverse auction platforms.

As previously mentioned, the scan of the electronically readable element is sent, using the electronic device associated with the buyer, to the online reverse bidding system. The scan may be sent to the online reverse bidding system using any suitable technique, such as, but not limited to, an SMS message, MMS message, messaging application message, social network post, email, video or the like, or any suitable combination thereof. In other embodiments of the invention, the online reverse bidding system may be accessed by the buyer through an application, such as an application downloaded to a mobile telephone, computing tablet or the like. In this way, the buyer may scan the electronically readable element directly into the online reverse bidding system through the application.

In some embodiments of the invention, one or more further pieces of information may be sent to the online reverse bidding system using the electronic device. Any suitable pieces of information may be sent, such as the buyer's name, age, gender, credit rating or the like. In a specific embodiment of the invention, the buyer's location may be sent to the online reverse bidding system. The buyer's location may be the buyer's home address, work address or the like. In another embodiment of the invention, the buyer's location may be the location at which the buyer has scanned the electronically readable element.

The buyer's location may be determined using any suitable technique. For instance, the online reverse bidding system may determine the buyer's location via IP geolocation, GPS, peer-to-peer, Wi-Fi, Bluetooth or the like, or any combination thereof. Preferably, the buyer's location is determined from the electronic device associated with the buyer.

It is envisaged that the buyer's location may be used to exclude sellers from the auction (for instance, sellers located too geographically remote from the buyer). Alternatively, the buyer's location may be used to, for instance, allow sellers in close proximity to a buyer to intervene in an auction. In other embodiments, the buyer's location may allow sellers to offer the buyer incentives or inducements based on the buyer's presence in, or close proximity to, a seller's store.

The online reverse bidding system may generate the purchase request based on the scan of the electronically readable element alone, or the scan of the electronically readable element and the one or more further pieces of information in combination. More preferably, however, in order to generate the purchase request, the online reverse bidding system may access one or more databases of electronically readable elements to identify the product that the user wishes to purchase.

The one or more electronic databases of electronically readable elements may include the electronic database of the one or more sellers, or may be a different electronic database. In some embodiments, the electronic database of electronically readable elements may be an external database, such as an electronic database maintained by a government authority, retail association or the like.

In an alternative embodiment of the invention, the online reverse bidding system may be associated with one or more application programming interfaces (APIs). In particular, the online reverse bidding system may be associated with one or more barcode APIs. In this embodiment of the invention, it is envisaged that, upon receipt of the scan of the electronically readable element by the online reverse bidding system, the online reverse bidding system may send the scan to a barcode API for identification of the product associated with the electronically readable element. Alternatively, the receipt of the scan of the electronically readable element by the online reverse bidding system may automatically actuate a barcode API associated with the online reverse bidding system to review the scan and identify the product associated with the electronically readable element.

In embodiments of the invention in which the online reverse bidding system is associated with a barcode API, it is envisaged that the purchase request may include an identification of the product associated with the electronically readable element. In other embodiments, purchase request may include a combination of an identification of the product associated with the electronically readable element and the one or more further pieces of information. In one specific embodiment of the invention, the purchase request may include an identification of the product associated with the electronically readable element and the buyer's location at the time of scanning the electronically readable element.

In another embodiment of the invention, the purchase request may include further information, such as whether the buyer wishes to collect the goods from the seller in person or whether the goods may be sent to the buyer (for instance, by post, courier, freight or the like). It is envisaged that the buyer may select whether it wishes to collect the goods or have them shipped to the buyer. Alternatively, the buyer may not have a preference about how the goods will be received.

In other embodiments, the buyer may include in the purchase request an indication of when it wishes to receive the goods. For instance, the buyer may require the goods urgently, or there may be no particular urgency in receiving the goods.

In another embodiment of the invention, the buyer may select a period of time for which the purchase request remains open (for instance, one hour, one day, one week, etc., or any other suitable period of time). It is envisaged that, if the buyer does not select the length of time for which the purchase request will remain open, the online reverse bidding system may automatically set an end time for the purchase request. For instance, the online reverse bidding system may set an end time of 24 hours after the purchase request has been generated. In other embodiments of the invention, the purchase request may remain open until the buyer accepts a preferred sale offer.

In other embodiments, the buyer may also include in the purchase request a preferred purchase price (e.g. a minimum purchase price, maximum purchase price, or both) so that the one or more sellers that receive the purchase request are aware of what minimum and/or maximum price the buyer would be happy to pay.

It is envisaged that the one or more sellers may access the online reverse bidding system using any suitable device. For instance, the one or more sellers may access the online reverse bidding system using any suitable electronic device. Preferably, however, the device includes a processor, electronic memory and a display. Thus, the device may comprise a desktop computer, laptop computer, computing tablet, mobile telephone or the like, or any suitable combination thereof.

In some embodiments of the invention, the one or more sellers may access the online reverse bidding system through a website. Alternatively, the online reverse bidding system may be accessed by the one or more sellers through an application, such as an application downloaded to a mobile telephone, computing tablet or the like.

It is envisaged that the online reverse bidding system may be housed on a server (such as, but not limited to, a cloud-based server), and users (i.e. buyers and sellers) are able to gain access to the online reverse bidding system through an internet connection whereby the user remotely accesses the online reverse bidding system. Preferably, the online reverse bidding system is provided with one or more user interfaces that are displayed on the display of the electronic device the user uses to access the online reverse bidding system.

In some embodiments, all users may access the same user interface. In other embodiments, the user interface that a user can access may be determined by the level of access granted to that user. It is envisaged that what an interface allows a user to do within the online reverse bidding system will be limited to only the relevant functionality for the user's level of access.

In a preferred embodiment of the invention, a user (whether a seller or buyer) may be required to register with the online reverse bidding system before access to the online reverse bidding system may be granted. A user may register by contacting an administrator and requesting registration. More preferably, however, registration is automated using the online reverse bidding system.

In embodiments of the invention in which registration is automated, registration as a user may be limited to users that can supply one or more predetermined pieces of information. For instance, a buyer may need to supply one or more pieces of information such as name, date of birth or address. In some embodiments of the invention, a buyer may also be required to register one or more payment credentials (financial institution account, credit or debit card, an account with an online payment system, a gift card, or any other account in which money may be withdrawn or deposited) so that, upon acceptance of a preferred sale offer, the purchase price (and, optionally, any additional charges such as freight, postage, administrative charges etc.) associated with the preferred sale offer can be transferred to the seller that provided the preferred sale offer.

It is envisaged that, in order to register as a seller, a seller will need to supply one or more pieces of information, such as name, address, the type of business operated by the seller (for instance, what goods or services the seller offers for sale), one or more payment credentials to which payment from a buyer may be received and the like. In some embodiments, registration as a seller may be limited to sellers having a registered business number or company number, a local business address, a current licence to sell particular products (for instance, a motor vehicle dealer licence) or the like, or any suitable combination thereof. In a preferred embodiment of the invention, the online reverse bidding system may be provided with a registration interface into which a user may enter their registration information.

It is envisaged that, once the user (and particularly a seller) has entered the required information into the registration interface, the online reverse bidding system may access one or more electronic databases to verify that the information supplied by the user is valid. The one or more electronic databases may include the electronic database of the one or more sellers, or may be a different electronic database. In some embodiments, the electronic database may be an external database, such as an electronic database maintained by a government authority (such as a government authority that issues motor vehicle dealer licences, an authority that maintains company and business registrations and the like).

If the online reverse bidding system is unable to verify that the information supplied by the user is valid, the user's application for registration may be refused. Alternatively, if the online reverse bidding system is able to verify that the information supplied by the user is valid, the user's registration may be accepted. If desired, a user may be required to pay a fee to the online reverse bidding system in order to complete the registration.

It is envisaged that, once a user has registered with the online reverse bidding system as a seller, the seller's registration may be maintained in the electronic database of one or more sellers. The user may amend or cancel their registration as required.

In some embodiments of the invention, the purchase request may be sent to all of the sellers maintained in the electronic database. More preferably, the purchase request is only sent to sellers that sell products similar to the product associated with the electronically readable element. For instance, if the buyer scans an electronically readable element associated with a garment, the purchase offer may only be sent to sellers of clothing. In other embodiments, more specific criteria may be used to determine which sellers receive the purchase request. For instance, the purchase request may only be sent to sellers of women's clothing, or sellers of the specific brand of women's clothing with which the electronically readable element is associated. Even more specifically, a seller may be required to provide its current stock list to the online reverse bidding system, such that the purchase offer may only be sent to sellers that have the specific item associated with the electronically readable element in stock.

In an alternative embodiment of the invention, the purchase offer may be sent to sellers that carry similar products to the specific item with which the electronically readable element is associated, so that a buyer may have access to a range of brands to select from. It is envisaged that a buyer may be able to select whether it wishes to receive sale offers from sellers that carry similar products to the specific item with which the electronically readable element is associated.

In other embodiments of the invention, the purchase offer may only be sent to sellers that are located within a particular distance from the buyer. This may be particularly the case if the buyer wishes to collect the product from the seller. In embodiments of the invention in which the buyer would be happy to have the product shipped to them, it is envisaged that the seller could be located in a different city, state or even country to the buyer.

The purchase request may be sent to at least one of the one or more sellers using any suitable technique. For instance, the purchase request may be sent via SMS message, MMS message, email or the like. Alternatively, the one or more sellers may receive a notification (such as an SMS message, MMS message, email, push notification or the like) that a new purchase request has been received in the online reverse bidding system.

In some embodiments of the invention, the one or more sellers may be required to manually generate a sale offer to be received by the reverse bidding system. For instance, a seller may manually enter a sale price into a user interface associated with the online reverse bidding system, or into an electronic communication (such as an SMS message, MMS message, email or the like). Alternatively, a seller may configure their account with the online reverse bidding system such that, when a purchase request is received, a sale offer is automatically generated and received by the online reverse bidding system. The sale price contained in the sale offer may be the lowest sale price the seller is prepared to offer for the product, or may be generated in response to a preferred purchase price entered by the buyer. In other embodiments, the sale price may be generated as a proportion of the recommended retail price of the product. For instance, the seller may automatically generate a sale offer that includes a sale price that is 90% of the recommended retail price, 80% of the recommended retail price and so on.

Preferably, a seller may be provided with an opportunity to generate one or more sale offers for the product. For instance, if a first seller generates an initial sale offer including a sale price that is subsequently beaten by a sale offer including a lower sale price submitted by a second seller, the first seller may generate a further sale offer including a sale price that is lower than the sale price offered by the second seller. It is envisaged that sellers may continue to generate sale offers until a preferred sale offer is accepted by the buyer, or the period of time for which the purchase request is open expires. In other embodiments of the invention, a seller may elect to stop generating sale offers when the sale price offered by another seller reaches a price below which the seller does not wish to sell the product. In these embodiments of the invention, a seller may manually generate further sale offers with the online reverse bidding system, or may automatically generate further sale offers based on predetermined criteria (such as, for instance, beating rival sale prices by offering a sale price that is a predetermined amount or percentage lower than the rival sale price until a sale price is reached below which the seller does not wish to generate further sale offers). In this embodiment of the invention, each of the one or more sellers may be able to view all sale offers generated by all of the one or more sellers. In other embodiments of the invention, a seller may only be able to view the current lowest sale offer. In other embodiments, a seller may not be able to view any sale offers other than their own, such that the reverse auction is in the form of a silent reverse auction.

In a preferred embodiment of the invention, a seller may be precluded from generating a sale offer if the seller does not have the product (or a similar product) in stock, or will not have the product (or a similar product) in stock by the time at which the purchase request will expire or conclude. In an alternative embodiment of the invention, a seller may be provided with an opportunity to withdraw the preferred sale offer if the product is no longer in stock (for instance, if the product sold out between the generation of the sale offer and the acceptance of the preferred sale offer).

If a seller withdraws an accepted sale offer, it is envisaged that the purchase request may remain active until such time as an alternative preferred sale offer is accepted, or the purchase requested expires at the end of the period of time for which the purchase offer was active. In some embodiments of the invention, the buyer may be required to accept an alternative preferred sale offer, or an alternative preferred sale offer may be automatically accepted. The alternative preferred sale offer may be automatically accepted if, for instance, a second sale offer complied with the buyer's predetermined criteria for accepting a preferred sale offer.

In another embodiment of the invention, the buyer may, upon generating a purchase request, be provided with a list of sellers that stock the product and/or similar products. The list of sellers may also include the price at which each seller is currently offering the product for sale. Thus, in some embodiments of the invention, the sale offer may simply comprise the current price at which the seller is offering the product (or a similar product) for sale. If the buyer is happy with a sale offer, the buyer may accept the sale offer as the preferred sale offer. Thus, in this embodiment of the invention, no reverse auction takes place.

If the buyer elects not to accept any of the sale offers, the buyer may then convert the purchase request into a purchase request for which a reverse auction takes place. At this point, at least one of the one or more sellers may generate a sale offer that is lower than the price at which the seller usually offers the product for sale.

The sale offers may be sent to the buyer using any suitable technique. For instance, the sale offers may be sent via SMS message, MMS message, app notification service, email or the like. Alternatively, the buyer may receive a notification (such as an SMS message, MMS message, email, push notification or the like) that a new sale offer has been received in the online reverse bidding system. Preferably, the buyer is able to view all sale offers, although in other embodiments of the invention, the buyer may only be able to view the current lowest sale offer.

It is envisaged that a sale offer will include certain pieces of information. At a minimum, the sale offer will include a price at which a product is offered for sale to the buyer. However, in some embodiments of the invention, the sale offer will also include the location of the product being offered for sale. This may be identified as a name of a retail store, a city, suburb, postcode, country, state, address, or any combination thereof. In some embodiments of the invention, a seller may elect to provide a geographic location of the product (such as a city, suburb, postcode etc.) but may elect to withhold the identity of the seller from the buyer (i.e. the name of the retail store or the like).

The buyer may reject or delete, or may simply ignore, sale offers it does not intend to accept. A buyer may manually accept a preferred sale offer with the online reverse bidding system, or a preferred sale offer may be automatically accepted with the online reverse bidding system based on certain predetermined criteria entered by the buyer (such as a sale price at which the buyer would be happy to accept a sale offer).

In some embodiments of the invention, the preferred sale offer need not be the sale offer including the lowest sale price. In this embodiment, it is envisaged that the buyer may accept a sale offer based on criteria other than sale price, such as a sale offer from a preferred seller, a sale offer where the product is located nearest to the buyer, a sale offer where the product is available for immediate collection and the like, or any suitable combination thereof.

Upon acceptance of the preferred sale offer, it is preferred that the seller associated with the preferred sale offer will receive a notification that its sale offer has been accepted as the preferred sale offer. The notification may be sent via SMS message, MMS message, email or the like. Alternatively, the seller may receive a notification (such as an SMS message, MMS message, email, push notification or the like) that its sale offer is the preferred sale offer in the online reverse bidding system. Upon receipt of the notification that its sale offer is the preferred sale offer, the seller may make the product available for collection by the buyer, or may prepare the product for shipping to the buyer.

In some embodiments of the invention, a buyer may be required to transfer an amount of money equal to the sale price (including any taxes, administration fees, shipping costs or the like) to the seller that generated the preferred sale offer prior to collection or shipping of the product. The transfer of the sale price may be achieved with the online reverse bidding system (such as through transfer from a payment credential of the buyer registered with the online reverse bidding system to a payment credential of the seller registered with the online reverse bidding system).

Alternatively, the transfer of the sale price may be conducted when the buyer collects the product from the seller using any suitable transaction (such as a cash transaction, credit or debit card transaction, electronic funds transfer or the like, or a combination thereof). In this way, when a buyer accepts a preferred sale offer from a retail store (or similar), the buyer may pay for the product at the retail store using conventional payment methods.

In embodiments of the invention in which the product is to be delivered to the buyer, the progress of the delivery may be tracked. In a specific embodiment of the invention, the progress of the delivery may be tracked in real-time, such that the buyer is aware of the geographic location of the product at all times (or at intervals of time) between the purchase of the products and the delivery of the product.

Optionally, notifications regarding the non-acceptance or rejection of sale offers may also be sent to any unsuccessful sellers.

It is envisaged that, in some embodiments of the invention, the online reverse bidding system may track the buying habits of a buyer. By “buying habits” it will be understood that this is intended to include one or more of the type of products that the buyer purchases, the frequency with which the buyer purchases products using the online reverse bidding system, the locations at which the buyer scans the electronically readable elements, the price of the products that the buyer purchases and so on. By tracking the buyer's buying habits in this way, the online reverse bidding system may send to the buyer information regarding, for instance, new products in which the buyer has an interest, sales on products in which the buyer has an interest (particularly products located in a geographic area close to the buyer) and so on. Alternatively, information regarding the buyer's buying habits may be provided to at least one of the one or more sellers, such that the seller may directly provide the buyer with product information, sales information, vouchers, discount codes, loyalty rewards and the like, and particularly information related to products in which the buyer has an interest.

In these embodiments, it is envisaged that the buyer may receive such information in any suitable form, such as an SMS message, MMS message, email or the like. Alternatively, the buyer may receive a notification (such as an SMS message, MMS message, email, push notification or the like) that information is available for the buyer to review in the online reverse bidding system.

In some embodiments of the invention, the buyer and/or one or more sellers may invite one or more further buyers to join the auction. The one or more further buyers may be invited using any suitable technique. For instance, the one or more further buyers may be existing users of the online reverse bidding system. The invitations may be sent randomly, may be sent to people known to the buyer who are also users of the online reverse bidding system, or may be sent to users of the system that have previously indicated an interest in purchasing products the same as, or similar to, the product that is the subject of the auction. In other embodiments of the invention, the online reverse bidding system may allow a buyer to link an account to the accounts of one or more other users of the online reverse bidding system so that linked users may be invited to join a buyer's auction, or the buyer may share an auction with the linked users.

In an alternative embodiment of the invention, the one or more further buyers may be invited through one or more social media accounts, through email, SMS or MMS message, push notification or the like, or any suitable combination thereof.

In some embodiments, the one or more further buyers may be known to the buyer. For instance, the buyer may choose to invite one or more friends or family members (for example) to join the auction.

In embodiments of the invention in which one or more further buyers join an auction, it is envisaged that each of the buyer and the one or more further buyers may wish to purchase one or more of the product. In this way, the seller may be able to offer multiple products for sale at the same time to multiple buyers. It is envisaged that selling multiple products simultaneously may allow the seller to offer a lower price per product to each of the buyers.

In some embodiments of the invention, an auction may be initiated by a seller. It is envisaged that these may be conventional auctions in which a plurality of buyers may place bids of increasing monetary value on a particular item offered for sale by a seller.

In a second aspect, the invention resides broadly in an online reverse bidding system including at least one computational device configured to:
a) Receive, from an electronic device associated with a buyer, an identifier associated with a product;
b) Generate a purchase request for the product, the purchase request being generated based on the identifier;
c) Maintain an electronic database of one or more sellers;
d) Send the purchase request to at least one of the one or more sellers;
e) Receive one or more sale offers from at least one of the one or more sellers in response to the purchase request; and
f) Accept a preferred sale offer.

Preferably, the electronic device comprises a mobile electronic device, such as a mobile telephone, computer tablet or the like.

The identifier may be of any suitable form. For instance, the identifier may include a scan of an electronically readable element. Any suitable electronically readable element may be used. For instance, the electronically readable element may include a barcode, such as a one dimensional barcode or a two dimensional barcode. In some embodiments of the invention, the electronically readable element may be a Quick Response (QR) code, while in other embodiments of the invention, the electronically readable element may comprise an RFID tag. It is envisaged that the scanning of the electronically readable element may be achieved using the electronic device, and particularly a camera associated with the electronic device.

In other embodiments of the invention, the identifier may include an image. In this embodiment of the invention, it is preferred that the image may be a digital image. More preferably, it is preferred that the image may be generated by a camera associated with the electronic device associated with the buyer. The image may be of any suitable subject. For instance, the image may be an image of the product, an image of a portion of a product (for instance, a portion of the product on which the brand is provided), an image of a serial number, manufacturer's label or the like, or any suitable combination thereof.

In embodiments of the invention in which the image contains text, it is envisaged that the text may be converted to a machine readable format. For instance, the image may be an Optical Code Reader (OCR) image.

In an alternative embodiment of the invention, the identifier may be entered manually by the buyer. In this embodiment of the invention, the identifier may be entered (e.g. by typing, converted from handwriting to text, etc.) as text into the electronic device.

In some embodiments of the invention, the identifier sent to the online reverse bidding system may include sufficient information to clearly identify the product. For instance, a barcode, an image of a manufacturer's label or serial number, etc. may provide sufficient information to allow the online reverse bidding system to identify the product and generate a purchase request.

It is envisaged that there may be times when the identifier may not contain sufficient information to identify the product. For instance, if a buyer enters an incomplete serial number into the online reverse bidding system, or misspells a product name, it may not be possible to identify a single product associated with the incomplete information entered by the buyer.

In this embodiment of the invention, it is envisaged that the online reverse bidding system may maintain an electronic product database. It is envisaged that the electronic product database may include information on a plurality of products. Any suitable information may be included in the electronic product database, including, but not limited to, product brands, names, serial or catalogue numbers, technical specifications, dimensions, energy efficiency and/or safety ratings, wholesale and/or retail prices, availability and so on, or any suitable combination thereof.

If the identifier sent to the online reverse bidding system does not include sufficient information to fully identify the product, the online reverse bidding system may consult the electronic product database to identify any products that match the incomplete information entered by the buyer. In this embodiment, it is envisaged that the buyer may be able to browse the electronic product database to identify and select the desired product, or the online reverse bidding system may provide the buyer with two or more products that match the incomplete information and request a selection from the buyer.

In some embodiments of the invention, the buyer and/or one or more sellers may invite one or more further buyers to join the auction. The one or more further buyers may be invited using any suitable technique. For instance, the one or more further buyers may be existing users of the online reverse bidding system. The invitations may be sent randomly, or may be sent to users of the system that have previously indicated an interest in purchasing products the same as, or similar to, the product that is the subject of the auction.

In an alternative embodiment of the invention, the one or more further buyers may be invited through one or more social media accounts, through email, SMS or MMS message, push notification or the like, or any suitable combination thereof.

In some embodiments, the one or more further buyers may be known to the buyer. For instance, the buyer may choose to invite one or more friends or family members (for example) to join the auction.

In embodiments of the invention in which one or more further buyers join an auction, it is envisaged that each of the buyer and the one or more further buyers may wish to purchase one or more of the product. In this way, the seller may be able to offer multiple products for sale at the same time to multiple buyers. It is envisaged that selling multiple products simultaneously may allow the seller to offer a lower price per product to each of the buyers.

In a third aspect, the invention resides broadly in an online reverse bidding system including at least one computational device configured to:
a) Generate a purchase request for a product;
b) Maintain an electronic database of one or more sellers;
c) Send the purchase request to at least one of the one or more sellers;
d) Receive one or more sale offers from at least one of the one or more sellers in response to the purchase request; and
e) Allow one or more buyers to access the one or more sale offers and, optionally, accept a preferred sale offer.

In a fourth aspect, the invention resides broadly in a reverse bidding method including at least one server, the reverse bidding method comprising the steps of:
a) generating, with an online reverse bidding system, a purchase request for a product;
b) maintaining an electronic database of one or more sellers in association with the online reverse bidding system;
c) sending, with the online reverse bidding system, the purchase request to at least one of the one or more sellers;
d) receiving, with the online reverse bidding system, one or more sale offers from at least one of the one or more sellers in response to the purchase request; and
e) allowing one or more buyers to access, with the online reverse bidding system, the one or more sale offers and, optionally, accept a preferred sale offer.

In these embodiments of the invention, it is envisaged that the online reverse bidding system may generate a purchase request without receiving the purchase request from a buyer. Instead, the online reverse bidding system may generate the purchase order for other purposes, for instance to assist retailers in clearing excess stock or stock that is on sale, to generate additional traffic to the online reverse bidding system, or the like.

In some embodiments, the sellers that send sale offers to the online reverse bidding system may publish or advertise the auctions. Preferably, the auctions may be published or advertised electronically, for instance on the seller's website, social media account, via an email, SMS message, MMS message, or the like, or any suitable combination thereof.

In another aspect, the invention resides broadly in a reverse bidding method including at least one server, the reverse bidding method comprising the steps of:
a) scanning, using an electronic device associated with a buyer, an electronically readable element associated with a product;
b) sending, with the electronic device, a scan of the electronically readable element to an online reverse bidding system
c) generating, with the online reverse bidding system, a purchase request for the product;
d) maintaining an electronic database of one or more sellers in association with the online reverse bidding system;
e) sending, with the online reverse bidding system, the purchase request to at least one of the one or more sellers;
f) receiving, with the online reverse bidding system, one or more sale offers from at least one of the one or more sellers in response to the purchase request; and
g) accepting, with the online reverse bidding system, a preferred sale offer.

In another aspect, the invention resides broadly in an online reverse bidding system including at least one computational device configured to:
a) Receive, from an electronic device associated with a buyer, a scan of an electronically readable element associated with a product;
b) Generate a purchase request for the product, the purchase request being generated based on the scan of the electronically readable element;
c) Maintain an electronic database of one or more seller;
d) Send the purchase request to at least one of the one or more sellers;
e) Receive one or more sale offers from at least one of the one or more sellers in response to the purchase request; and
f) Accept a preferred sale offer

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a schematic view of a reverse bidding method according to an embodiment of the present invention.

FIG. 2 illustrates a user interface of an online reverse bidding system according to an embodiment of the present invention.

FIG. 3 illustrates user interfaces of an online reverse bidding system according to an embodiment of the present invention.

FIG. 4 illustrates a user interface of an online reverse bidding system according to an embodiment of the present invention.

FIGS. 5A, 5B and 5C illustrate user interfaces of an online reverse bidding system according to an embodiment of the present invention.

FIG. 6 illustrates a schematic view of an online reverse bidding method according to an embodiment of the present invention.

FIGS. 7A to 7F illustrate steps in an online reverse bidding method according to an embodiment of the present invention.

FIGS. 8A to 8E illustrate steps in an online reverse bidding method according to an embodiment of the present invention.

FIGS. 9A to 9C illustrate steps in an online reverse bidding method according to an embodiment of the present invention.

FIGS. 10 to 12 illustrate seller interfaces in an online reverse bidding system according to an embodiment of the present invention.

### DESCRIPTION OF EMBODIMENTS

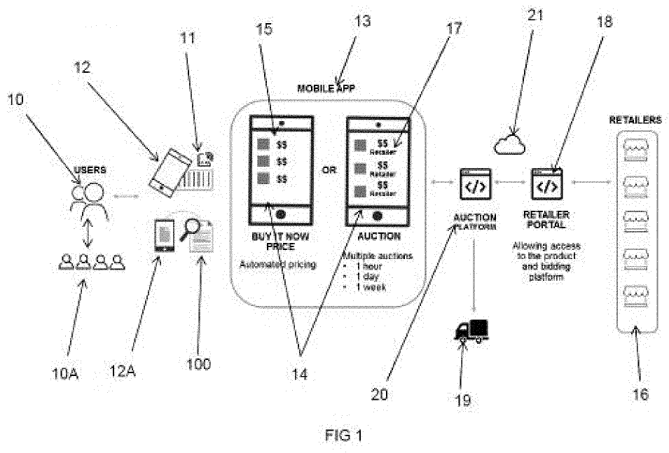

In FIG. 1 there is illustrated a schematic view of a reverse bidding method according to an embodiment of the present invention. In this Figure, a buyer 10 visits a retail store in which products are offered for sale, the products being labelled in the store with an electronically readable element 11 (in the form of a barcode or RFID tag). The buyer 10 scans the electronically readable element 11 using a mobile electronic device 12 such as a mobile telephone or computer tablet. In particular, the electronically readable element 11 is scanned using the camera of the electronic device 12 into an application 13 downloaded to the electronic device 12. Alternatively, as shown in FIG. 1, a buyer 10 may use the mobile electronic device 12A to convert text 100 associated with a product into a machine readable form. For instance, the text 100 may be converted using Optical Character Recognition (OCR) software or the like. The text 100 may part (or all) of a manufacturer's label, serial number, product brochure, product manual, swing tag or the like, or a combination thereof. The buyer 10 may, if it wishes, include a preferred purchase price in the purchase request.

When the buyer 10 scans the electronically readable element 11, the application 13 identifies the product associated with the electronically readable element 11 to generate a purchase request and displays, on a display 14 of the electronic device 12 a list of sale offers 15 in response to the purchase request, the sale offers 15 being a list of sellers 16 offering the product (or a similar product) for sale and the price at which the sellers 16 are offering the product for sale (i.e. a “buy it now” price). The buyer 10 may elect to accept one of the sale offers 15 at which point the accepted sale offer 15 becomes the preferred sale offer.

Alternatively, the buyer 10 may choose not to accept any of the sale offers 15, and may instead convert the purchase request into a reverse auction purchase request. To do so, the buyer 10 chooses a period of time for which the purchase request is to remain open (and during which sellers 16 can submit sale offers). Upon commencement of the reverse auction, at least one of the one or more sellers 16 may submit auction sale offers 17 which are displayed to the buyer 10 on the display 14 of the electronic device 12. Each seller 16 may submit a single sale offer 17 or may submit multiple sale offers 17 with progressively lower sale prices as other sellers 16 submit sale offers 17. The buyer 10 may accept a preferred sale offer at any point during the reverse auction, or may wait until the end of the auction (at which point no further sale offers 17 may be submitted) before accepting a preferred sale offer. Once a preferred sale offer is accepted the product may then be picked up in person from the seller 16 by the buyer 10 or may be prepared for delivery 19 to the buyer 10.

In FIG. 1 it may be seen that the sellers 16 access the application 13 using a retailer portal 18. It is envisaged that the retailer portal 18 is where the sellers register themselves and/or their businesses/stores with the application 13. Thus, the retailer portal 18 requires sellers 16 to identify the name of the store, the type of products offered for sale by the store, the location of the store and so on. Preferably, sellers 16 enter further information such as stock levels into the retailer portal 18 such that, for instance, a seller 16 is unable to submit a sale offer 15, 17 for a product which is not currently in stock.

Both the buyer 10 and the sellers 16 make use of the auction platform 20 of the application 13. The auction platform is a Cloud 21 based platform to which sale offers 17 are submitted by the sellers 16 and accessed by the buyer 10.

In FIG. 1, the buyer 10 may also invite one or more additional buyers 10A to join the auction. When additional buyers 10A are added to the auction, it is envisaged that the buyer 10 and each of the additional buyers 10A intend to purchase at least one of the product, meaning that sellers 16 have an opportunity to make multiple sales of the product simultaneously. Thus, sellers 16 may be encouraged to submit sale offers 17 of a lower monetary value than sale offers 17 if only a single buyer 10 was purchasing the product. In this way, sellers 16 may benefit from making multiple sales, while buyers 10, 10A may also benefit by paying lower prices for the product.

In an alternative embodiment of the invention, the creation of a reverse auction may not be reliant on a buyer 10 visiting a store and scanning an electronically readable element 11, or converting text 100, to generate a purchase request. Instead, the auction platform 20 may generate a purchase request based on any suitable factor (such as assisting sellers 16 clear excess or slow-selling stock, attempting to attract additional traffic to the application 13, or the like). The auction platform 20 may generate the purchase request with or without the knowledge and/or input of the sellers 16. The purchase request generated by the auction platform 20 may or may not include a preferred purchase price for the product.

Once a purchase request is generated, an auction generated by the auction platform 20 proceeds in much the same manner as an auction generated by a buyer 10. Sellers 16 may generate sale offers 15 in response to the purchase request, the sale offers 15 being a list of sellers 16 offering the product (or a similar product) for sale and the price at which the sellers 16 are offering the product for sale (i.e. a “buy it now” price). The buyer 10 may elect to accept one of the sale offers 15 at which point the accepted sale offer 15 becomes the preferred sale offer.

As a buyer 10 did not generate the purchase request in this instance, the buyer 10 will not necessarily be immediately aware of the sale offers 15. Thus, there are a number of ways in which a buyer 10 may be made aware of sale offers 15 in an auction generated by the auction platform 20. For instance, a buyer 10 may periodically review the application 13 for any auction platform-generated sales offers 15. Alternatively, the auction platform 20 may send electronic notifications (SMS message, MMS message, email, push notification or the like) to all buyers 10 registered with the auction platform 20 and/or application 13, or may target specific buyers 10, such as ones that have previously purchased, or expressed an interest in, particular products. Alternatively, buyers 10 may be targeted based on certain characteristics of the buyer (such as age, gender, geographic location, purchasing habits, income or the like, or any combination thereof).

In some embodiments of the invention, the one or more sellers may also promote or advertise the auction generated by the auction platform 20 through their websites or other electronic presences (social media accounts or the like) to generate additional interest in, and potential buyers for, the product.

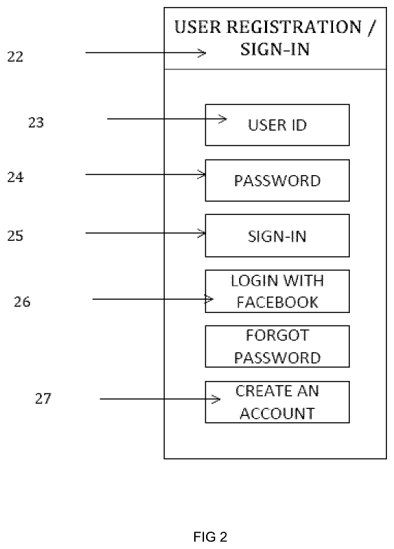

FIG. 2 illustrates a user interface of an online reverse bidding system according to an embodiment of the present invention. The interface in FIG. 2 is a login interface 22 in which a buyer gains access to the application. The login interface 22 is displayed on the display of a mobile electronic device.

The login interface 22 allows a user to enter their user name into the username box 23 and their password into the password box 24. Once this information is entered, the buyer presses the Sign In button 25 to access the application. Alternatively, the buyer may log in to the application using an alternative form of identification, such as a social media account login 26. New users of the application may create an account with the application by pressing the “Create an account” button 27.

FIG. 3 illustrates user interfaces of an online reverse bidding system according to an embodiment of the present invention. The user interfaces of FIG. 3 are the new user interfaces 28. When a new user presses the “Create an account” button shown in FIG. 2, the new user is required to enter certain personal information, such as their name 29, email address 30, password 31, date of birth 32 and address 33. Once this information is entered, the new user will press the “Register” button 34. However, prior to the completion of registration, the new user is required to register a payment credential to which payments for purchased products will be charged.

The new user may register any suitable payment credential, such as a credit or debit card 35, an online payment system (such as Apple Pay 36 or Paypal 37) or an “Other” payment credential 38, such as a financial institution account. Once the new user has finished entering their registration details, the new user presses the “Register” button 39 to register their new account with the application.

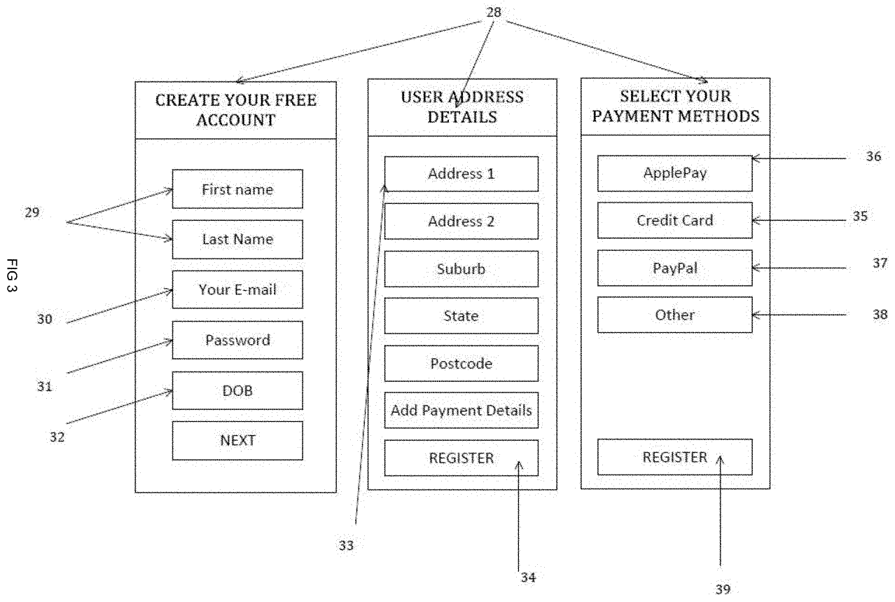

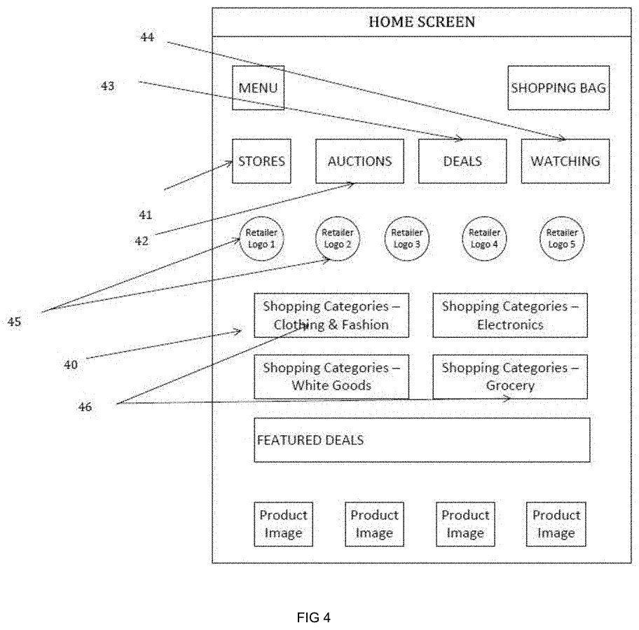

FIG. 4 illustrates a user interface of an online reverse bidding system according to an embodiment of the present invention. The user interface shown in FIG. 4 is a buyer's home interface 40 by which it is meant the interface that the buyer first sees when logged into the application.

In the home interface 40, a buyer may bring up interfaces showing lists of stores 41 registered with the application (i.e. sellers), a list of auctions 42, a list of current deals 43 being offered by sellers, and a list of the buyer's watched products 44.

In the list of stores 41, a buyer may select from specific stores 45 registered with the application, or browse products by category 46.

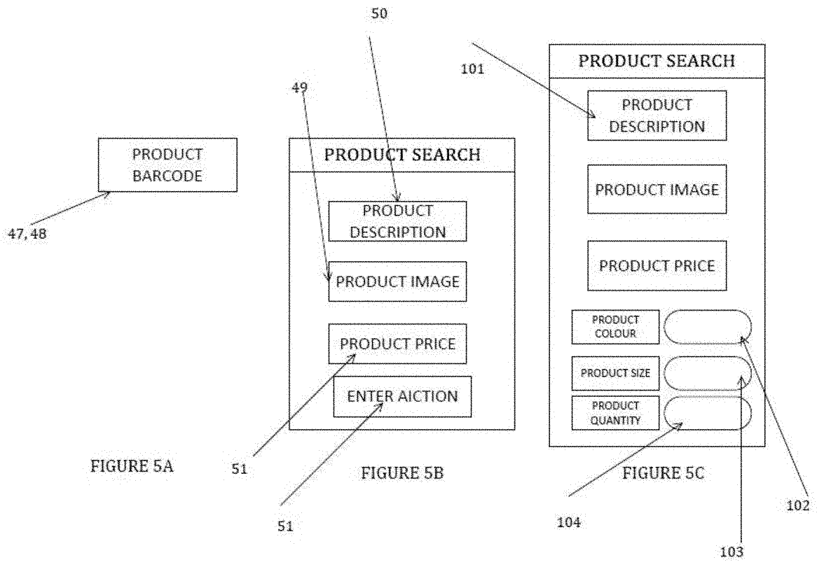

FIGS. 5A and 5B illustrate user interfaces of an online reverse bidding system according to an embodiment of the present invention. In FIG. 5A, a buyer is in a store and locates a product that they wish to purchase. The buyer scans an electronically readable element in the form of a barcode 47 associated with the product in a scanning interface 48. Alternatively, the buyer could scan an RFID tag if present, or perform an OCR scan of text associated with the product.

The online reverse bidding system accesses one or more databases of electronically readable elements in order to identify the product associated with the scanned barcode 47. Once the online reverse bidding system identifies the product, an image of the product 49 and/or a written description 50 of the product is displayed in the user interface shown in FIG. 5B. A “buy it now” price 51 is also displayed, the “buy it now” price 51 being the price at which a buyer could immediately buy the product without generating a reverse auction.

If the buyer does not wish to pay the “buy it now” price 51 for the product, the buyer may press the “Enter Auction” button 52 to generate a reverse auction for the product.

In FIG. 5C, an interface 101 is illustrated in which the buyer may enter further details of the product 49 that they wish to purchase. The further details (including the preferred colour 102, size 103 and quantity 104) may be entered regardless of whether the buyer wishes to purchase the product immediately or send the product to an auction.

FIG. 6 illustrates a schematic view of a reverse bidding method according to an embodiment of the present invention. The method of FIG. 6 is similar to that of FIG. 1, except that when the buyer 10 scans an electronically readable element 11 with a mobile electronic device 12, or converts text 100 associated with a product to an electronic scan (such as an OCR scan) using the mobile electronic device 12A, both the scan of the electronically readable element 12 or the text 100 and the location 53 at which the buyer 10 has scanned the electronically readable element 12 or scanned text 100 are transmitted to the application 13 so that the product can be identified, as well as sellers 16 located in relatively close geographic proximity to the location 53.

In the embodiment of the invention shown in FIG. 6, the system further includes a seller upload portal 54. Sellers 16 access the seller upload portal 54 to enter information such as the number and types of products in stock, the location of the products (for instance, if the seller has more than one retail store), the electronically readable elements associated with the products and so on. In this way, the application 13 may identify, using one or more electronic databases 56, which sellers 16 have the buyer's 10 desired product in stock and/or are located relatively close to the location 53. In this embodiment, only sellers 16 meeting these criteria may be able to send sale offers 55 to the buyer 10.

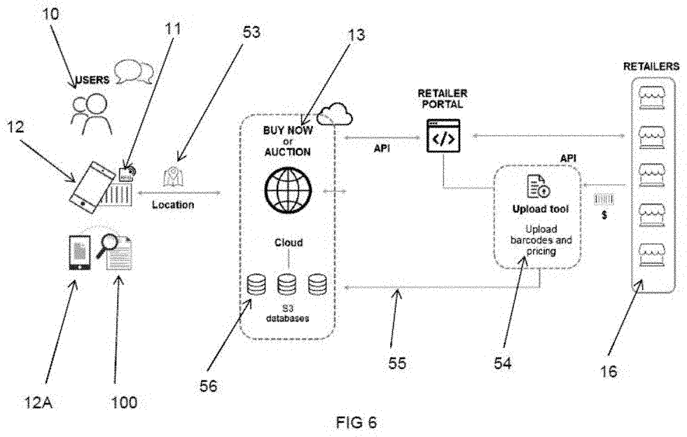

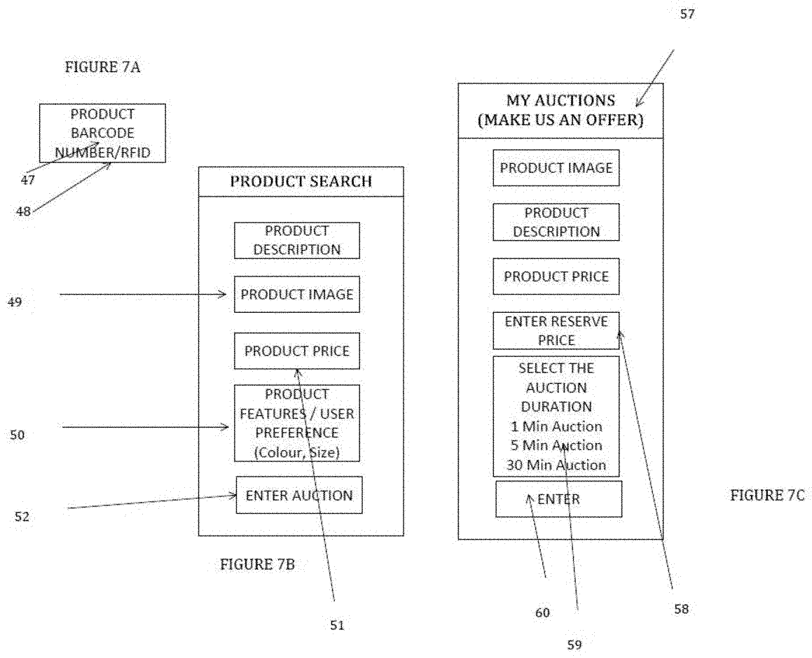

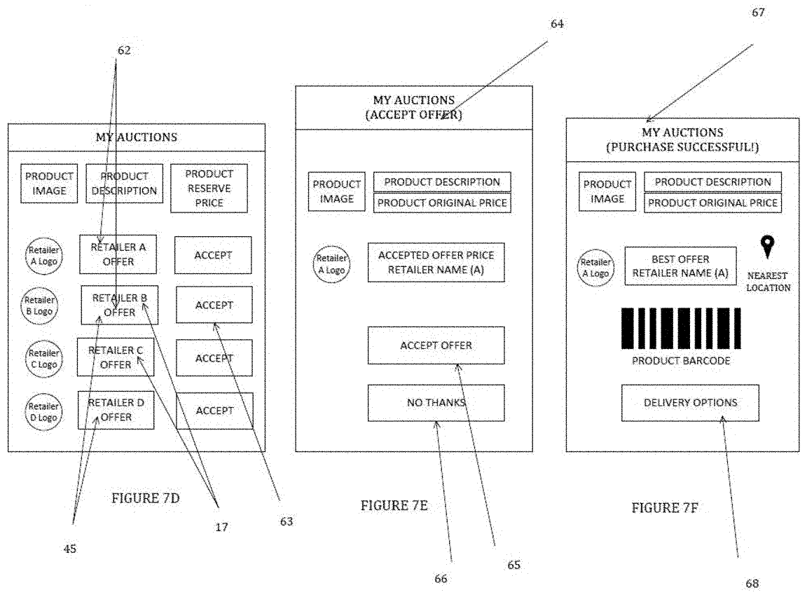

FIGS. 7A to 7F illustrate steps in a reverse bidding method according to an embodiment of the present invention. In FIG. 7A, a buyer scans an electronically readable element in the form of a barcode 47 into the scanning interface 48 of the application. The application consults an electronic database of electronically readable elements to identify the product associated with barcode 47 and, once identified, displays an image of the product 49, a written description 50 of the product (including the buyer's preferred size, colour and quantity information) and a “buy it now” price 51 of the product to the buyer, as shown in FIG. 7B. In the embodiment of the invention shown in FIG. 7B, the buyer does not wish to pay the “buy it now” price 51 and instead wishes to generate a reverse auction (i.e. generate a purchase request) by pressing the “Enter Auction” button 52.

When the “Enter Auction” button 52 is pressed, the buyer generates the purchase request by entering certain information into the purchase request interface 57 shown in FIG. 7C. The buyer generates the purchase request by entering a reserve price 58 (i.e. the maximum price the buyer wishes to pay for the product) into the purchase request interface 57. The buyer also selects the period of time 59 for which the purchase request will remain open for sellers to submit sale offers. The buyer then presses the “Enter” button 60 to start the reverse auction.

FIG. 7D illustrates a list of sale offers 17 for the product submitted to the buyer. The sale offers 17 identify the sellers 45 and the sale price 62 associated with the sale offer 17. A buyer can accept a sale offer 17 by pressing the “Accept” button 63 next to their chosen sale offer.

When a buyer presses the “Accept” button 63 on the chosen sale offer 17, the accept offer interface 64 as shown in FIG. 7E is displayed. The buyer may then accept the offer by pressing the “Accept offer” button 65 (at which point the sale offer becomes the preferred sale offer) or return to the list of sale offers 17 by pressing the “No thanks” button 66.

Once the buyer has completed their payment for the preferred sale offer (using their selected payment option), the purchase of the product is confirmed in the confirmation interface 67 shown in FIG. 7F. The buyer may then elect to collect the product from the seller, or may arrange delivery of the product by pressing the “Delivery options” button 68.

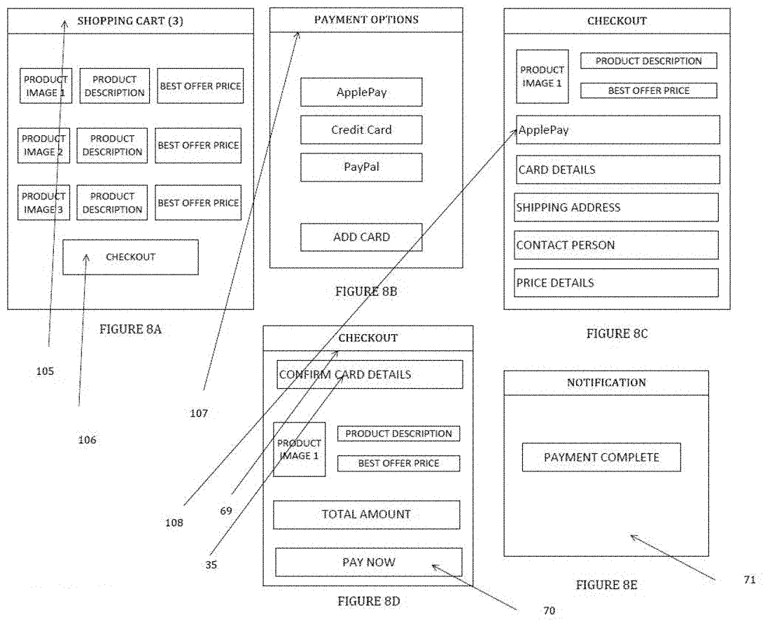

FIGS. 8A to 8E illustrate steps in a reverse bidding method according to an embodiment of the present invention. When a buyer accepts a sale offer to generate a preferred sale offer, the buyer is then transferred to the shopping cart interface 105 as illustrated in FIG. 8A. The buyer can select the items in its shopping cart it wishes to pay for and then the buyer will press the “Check Out” button 106. Pressing the “Check Out” button 106 will transfer the buyer to a payment options interface 107 as shown in FIG. 8B. In the payment options interface 107, the buyer can select their preferred payment option. For instance, if the buyer wishes to pay using Apple Pay, the buyer selects this option in the payment options interface 107 and is transferred to the Apple Pay checkout interface 108 as shown in FIG. 8C. Similarly, if the buyer selects the credit card payment option in the payment options interface 107, the payment is transferred to the credit card checkout interface 69 illustrated in FIG. 8D. The buyer selects a payment credential registered with the application (in this case a credit/debit card 35) from which payment for the product will be deducted and transferred to the seller. When the buyer has selected the preferred payment credential (for instance, if more than one payment credential is registered with the system), the buyer presses the “Pay Now” button 70 to pay for the product. A payment completion interface 71 as shown in FIG. 8E is then displayed to confirm the buyer's payment.

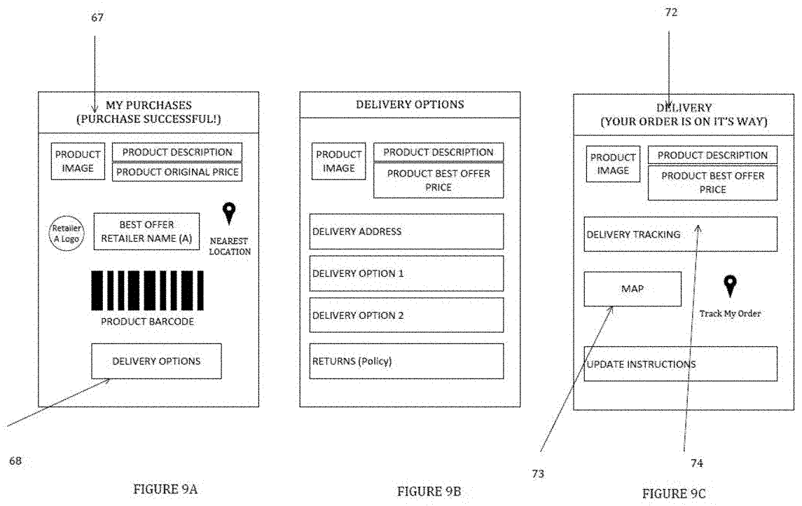

FIGS. 9A to 9C illustrate steps in a reverse bidding method according to an embodiment of the present invention. FIG. 9A illustrates a confirmation interface 67 similar to that shown in FIG. 7F. In this embodiment of the invention, the buyer may press the “Delivery options” button 68 to arrange delivery of the product. The buyer may then be provided with delivery options as shown in FIG. 9B. In this instance, the buyer can select a delivery option that will ensure the product arrives more quickly, but at an additional cost. The delivery options may be provided by the seller, third parties, or a combination of the two. The buyer may then track the delivery of the product in the delivery interface 72 shown in FIG. 9C. The delivery interface 72 illustrates the current location 73 of the product, as well as an estimated delivery time 74.

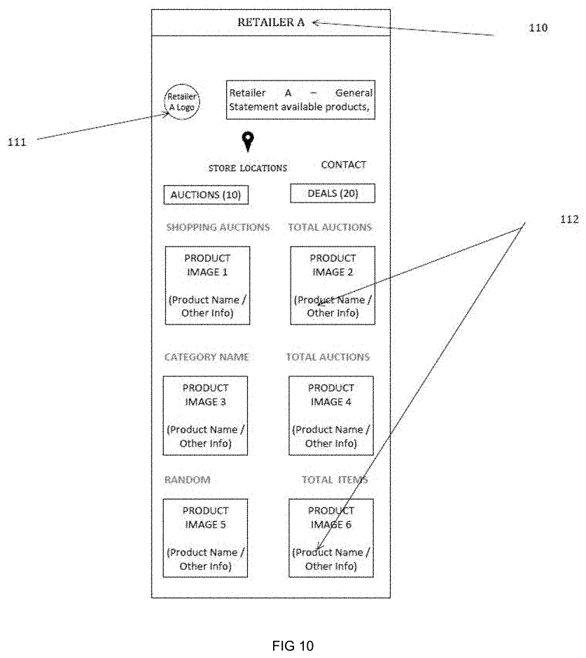

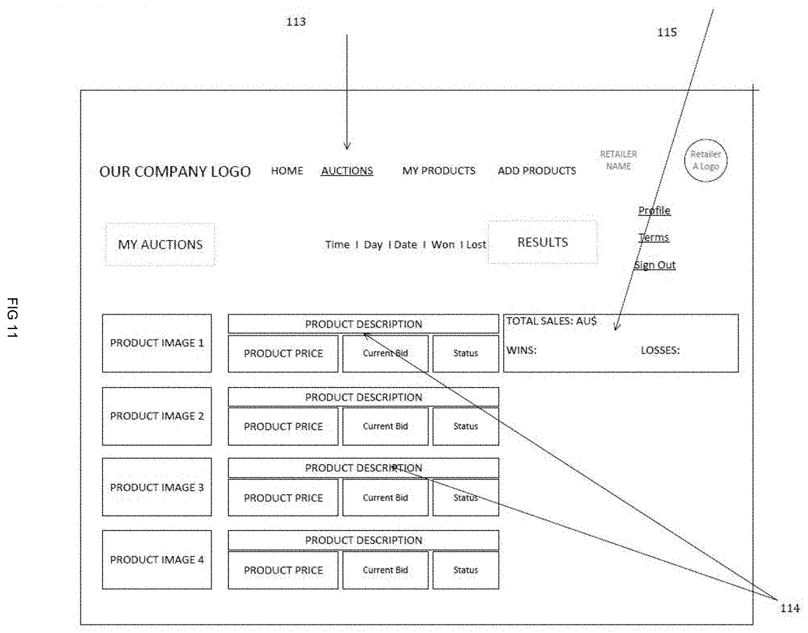

In FIG. 10 a user interface of the online reverse bidding system is illustrated. In particular, the user interface of FIG. 10 is a seller home interface 110. In the seller home interface 110, the seller 111 is identified, along with other details of the seller 111 (including contact details).

It is envisaged that a buyer may access the seller home interface 110 to view details of the seller 111, as well as to browse the products 112 the seller has for sale or auction, along with any special offers relating to the products 112.

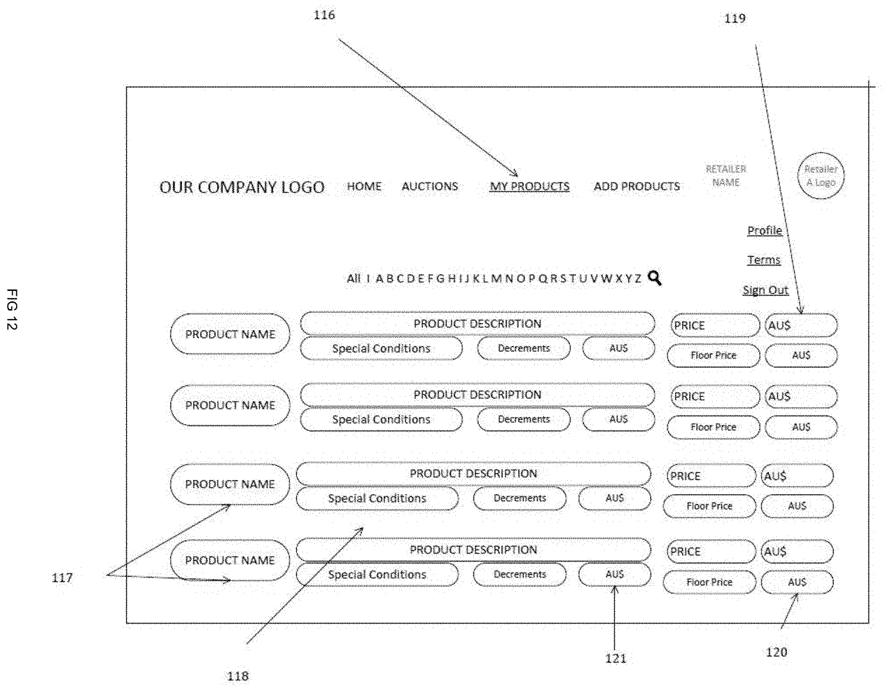

In FIG. 11 a user interface of the online reverse bidding system is illustrated. The user interface illustrated in FIG. 11 is envisaged as an interface that is only visible to a seller. In particular the user interface is a seller auction interface 113 in which the seller's auctions 114 are listed. The seller auction interface 113 allows a seller to track total sales 115 made through the online reverse bidding system.

In FIG. 12 a user interface of the online reverse bidding system is illustrated. The user interface illustrated in FIG. 12 is envisaged as an interface that is only visible to a seller. In particular the user interface is a seller product interface 116 in which the seller's products 117 are listed.

In the seller product interface 116, the seller may list product details 118, an initial sale price 119, a floor price 120 (i.e. the price below which the seller will not offer the product for sale), and the auction decrements 121 (i.e. the monetary amount by which the seller will reduce its sale price when lower sale offers are received during an auction).

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A reverse bidding method including at least one server, the reverse bidding method comprising the steps of:
a. entering, using an electronic device associated with a buyer, an identifier associated with a product;
b. sending, with the electronic device, the identifier to an online reverse bidding system;
c. generating, with the online reverse bidding system, a purchase request for the product;
d. maintaining an electronic database of one or more sellers in association with the online reverse bidding system;
e. sending, with the online reverse bidding system, the purchase request to at least one of the one or more sellers;
f. receiving, with the online reverse bidding system, one or more sale offers from at least one of the one or more sellers in response to the purchase request; and
g. accepting, with the online reverse bidding system, a preferred sale offer.

2. A reverse bidding method according to claim 1, wherein the electronic device is a mobile electronic device.

3. A reverse bidding method according to claim 2, wherein the mobile electronic device is a mobile telephone or computer tablet.

4. A reverse bidding method according to claim 1, wherein the identifier comprises a scan of an electronically readable element or an image.

5. A reverse bidding method according to claim 1, wherein the buyer is located within a retail store when scanning the electronically readable element.

6. A reverse bidding method according to claim 1, wherein, on receipt of the identifier, the online reverse bidding system identifies the product associated with the identifier.

7. A reverse bidding method according to claim 6, wherein the online reverse bidding system is associated with one or more barcode APIs adapted to identify the product associated with the identifier.

8. A reverse bidding method according to claim 1, wherein the purchase request includes the identifier and one or more further pieces of information relating to the buyer.

9. A reverse bidding method according to claim 1, wherein the purchase request is sent only to one or more sellers that sell products similar to the product associated with the identifier.

10. A reverse bidding method according to claim 1, wherein each of the one or more sale offers include a sale price.

11. A reverse bidding method according to claim 1, wherein the purchase request includes a preferred purchase price.

12. A reverse bidding method according to claim 11, wherein each of the one or more sellers may generate an initial sale offer in response to the purchase request, and one or more further sale offers.

13. A reverse bidding method according to claim 12, wherein a first of the one or more sellers generates a further sale offer when a sale offer generated by a second of the one or more sellers includes a sale price lower than a sale price included in an initial sale offer generated by the first of the one or more sellers.

14. A reverse bidding method according to claim 1, wherein, upon accepting the preferred sale offer, the buyer is required to transfer an amount of money equal to a sale price to the seller that generated the preferred sale offer.

15. A reverse bidding method according to claim 1, wherein at least one of the one more sellers comprises a retail store.

16. An online reverse bidding system including at least one computational device configured to:
a. Receive, from an electronic device associated with a buyer, an identifier associated with a product;
b. Generate a purchase request for the product, the purchase request being generated based on the identifier;
c. Maintain an electronic database of one or more sellers;
d. Send the purchase request to at least one of the one or more sellers;
e. Receive one or more sale offers from at least one of the one or more sellers in response to the purchase request; and
f. Accept a preferred sale offer.

17. An online reverse bidding system according to claim 16, wherein the electronic device associated with the buyer comprises a mobile electronic device.

18. An online reverse bidding system according to claim 17, wherein the mobile electronic device comprises a mobile telephone or computer tablet.

19. An online reverse bidding system according to claim 16, wherein the online reverse bidding system tracks the buyer's buying habits to provide the buyer with information related to products in which the buyer has an interest.

20. An online reverse bidding system including at least one computational device configured to:
a. Generate a purchase request for a product;
b. Maintain an electronic database of one or more sellers;
c. Send the purchase request to at least one of the one or more sellers;
d. Receive one or more sale offers from at least one of the one or more sellers in response to the purchase request; and
e. Allow one or more buyers to access the one or more sale offers and, optionally, accept a preferred sale offer.

21. A reverse bidding method including at least one server, the reverse bidding method comprising the steps of:
a. generating, with an online reverse bidding system, a purchase request for a product;
b. maintaining an electronic database of one or more sellers in association with the online reverse bidding system;
c. sending, with the online reverse bidding system, the purchase request to at least one of the one or more sellers;
d. receiving, with the online reverse bidding system, one or more sale offers from at least one of the one or more sellers in response to the purchase request; and
e. allowing one or more buyers to access, with the online reverse bidding system, the one or more sale offers and, optionally, accept a preferred sale offer.
